(19) United States
(12) Patent Application Publication
(10) Pub. No.: US 2022/0080533 A1
(43) Pub. Date: Mar. 17, 2022

(54) METHOD FOR PROCESSING A STRIP

(71) Applicant: Berndorf Innovations und Technologie GmbH, Berndorf (AT)

(72) Inventors: Markus HAYDN, Guntramsdorf (AT); Ataollah JAVIDI, Wien (AT); Stephanie LEGRAS, Wien (AT)

(73) Assignee: Berndorf Innovations und Technologie GmbH, Berndorf (AT)

(21) Appl. No.: 17/295,064

(22) PCT Filed: Nov. 20, 2019
(86) PCT No.: PCT/AT2019/060394

§ 371 Date: May 19, 2021

(30) Foreign Application Priority Data
Nov. 20, 2018 (AT) A 51015/2018

(51) Int. Cl. B23K 33/00; B23K 31/10; B05D 1/02

(52) U.S. Cl. CPC B23K 33/004; B23K 2101/16; B05D 1/02; B23K 31/10

(57) ABSTRACT

A method processes a belt with a belt body that has a first surface and a second surface connected to each other by side surfaces. Each side surface is smaller than each surface. At least one of the surfaces of the belt is coated with a coating having at least one layer. In a step i) the coating is interrupted or left out in a region of the belt to be processed, and a recess, in particular a gap-shaped or hole-shaped recess, interrupting the coating is produced in the region to be processed, which recess is at least partially delimited by opposite sections of the at least one coating. In a step ii) directly thereafter or after further intermediate steps, the recess is at least partially filled up with at least one material of the same type as that of the at least one layer of the coating.

The invention relates to a method for processing a belt with a belt body, wherein the belt body has a first surface and a second surface, wherein the first surface and the second surface are connected to one another by side surfaces, wherein each of the side surfaces is smaller than each of the surfaces, wherein at least one of the surfaces of the belt is coated with a coating having at least one layer.

Processing belts provided with a coating entails the problem that the coating is in the way of processing. Hence, it is important, for example for coated belts, which in further consequence are to be closed into endless belts, to carry out this operation without damaging the coating. For example, to connect free ends of such a belt to one another, they can be welded together on a coating-free side of the belt body opposite the coating, which, however, involves a significant risk of damaging the coating. Moreover, the belt material may be alloyed during welding due to the coating in the region of the welding location, whereby its properties can be considerably changed locally.

Repairing the belt body of coated belts also proves difficult as the belt body is usually only freely accessible from an uncoated bottom side of the belt. In addition, it is very difficult to perform complex repairs to the coating by oneself.

The object of the present invention was to overcome the disadvantages of the prior art and to improve and to facilitate the processing of a coated belt, wherein the coating of the processed belt as well as the belt body itself is not to be damaged.

This object is achieved by a method of the initially mentioned type according to the invention in that in a first step i) a recess, in particular a gap-type or hole-type recess, interrupting the coating is created around a region of the belt to be processed, which recess is at least partially delimited by opposite sections of the at least one coating, wherein after processing the belt in the region to be processed, in a step ii) the recess is at least partially filled up with at least one material of the same type as that of the at least one layer of the coating.

The invention allows in a simple manner the processing, for example in the context of a repair, of a belt, also of a surface having a coating. By the solution according to the invention, the simple production of endless belts being continuously coated on one side or on both sides is also possible. At this point, it should be noted that in the present context, processing a belt may be understood in particular as both repairing a belt in an endless or an open state and the process of making a belt endless.

According to a preferred variant of the invention, the belt body may be made from metal.

It has proven particularly advantageous if the coating is made from a non-metal material, in particular from a plastic, for example a polytetrafluoroethylene (PTFE).

According to a variant of the invention, which is particularly suitable for processing the belt body, it may be provided that a bottom of the recess is formed by a coating-free section of the surface of the belt body, wherein opposite sections of the coating delimiting the recess are separated from each other by the coating-free section of the surface of the belt body.

In an advantageous advancement of the invention, which is particularly suitable for producing endless belts, it may be provided that in step i) the coating is applied to the surface of the belt body, wherein at free ends of the belt body extending transversely or obliquely to the side surfaces, one region each of the surface of the belt body, which in each case, is delimited on one side by a free end of the belt body, is kept free of the coating.

Moreover, it may be provided that after step i) and before step ii), for producing the recess, end edges of the two free ends, which are kept free of the coating, are made to abut one another and are connected to each other, whereby the belt body is connected to form an endless belt.

Moreover, it is advantageous if the two free ends are welded to one another, forming a weld seam.

In order to obtain a uniform layer thickness, particularly when using a spraying method for applying the material of the coating in step ii), it is advantageous that toward the middle of the recess, the coating is slanted and/or staggered, in each case forming one upper side and steps adjoining it and having front sides, wherein in the case of a staggering, a level of the upper sides of the steps decreases from an edge of the recess towards a middle of the recess with respect to the surface of the belt body. By this variant of the invention, it can be ensured that after a coating of the processed location, both a central middle region of the recess and its edge regions have an approximately equal layer thickness, particularly when, in case of using a spraying method (spray coating), an amount of coating material inside a jet of coating material directed at the location to be coated decreases radially to the central axis. Also when using a method in which the coating material is poured on, in this variant of the invention, the material can reach the edge regions in a controlled manner after filling the middle part of the recess and it can spread in the recess, so that an approximately uniform thickness of the coating is achieved. In addition to this, this variant of the invention ensures that covering neighboring regions of the region to be processed can be dispensed with, as due to the staggering, even an undesired passing over of material into neighboring regions can be prevented or at least significantly reduced. This is particularly advantageous as the covering may cause damages to the coating.

In an advantageous embodiment, which is particularly suitable for repairing existing belts, it may be provided that between step i) and step ii), the coating is removed, forming at least a sloping surface and/or steps, until the surface of the belt body is exposed and on it, the belt body is processed, in particular by grinding and/or cutting out parts of the belt body and inserting material into the belt body.

A particularly exact adjustment of the layer thickness can be achieved by using a spraying method for filling up the recess with the material of the coating.

For the purpose of better understanding of the invention, it will be elucidated in more detail by means of the FIGURE below.

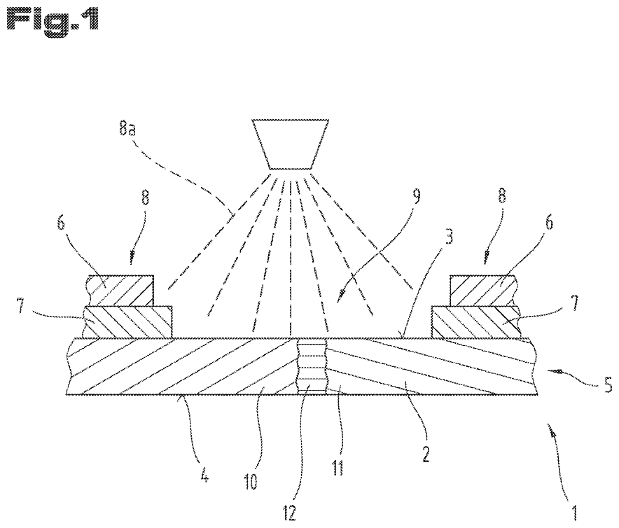

FIG. 1 shows in a very simplified, schematic representation a cross-section of a belt to be coated during the processing according to the invention.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted FIGURE and in case of a change of position, these specifications of location are to be analogously transferred to the new position.

According to FIG. 1, a belt 1 having a belt body 2 is used in the method according to the invention, which belt body 2 has a first surface 3 and a second surface 4. The belt body 2 is preferably made of metal.

The first surface 3 and the second surface 4 are connected by means of side surfaces 5, wherein each of the side surfaces 5 is smaller than each of the surfaces 3, 4. In the depicted exemplary embodiment, one of the surfaces 3, 4 of the belt 1, namely surface 3, is coated with a coating 8 having two layers 6, 7 in this case. The coating 8 may be applied for example by spraying on, pouring on one material and/or multiple different materials 8a, or by varnishing using the material and/or the materials 8a. Different from the representation in FIG. 1, the coating 8 may also be applied to both surfaces 3 and 4. Additionally, the coating 8 may also have only a single layer or also more than two layers, for example three, four or five and/or any desired number of layers. It is also possible to apply one or multiple layers of bonding agents between the bottommost layer 7 and the surface of the belt body 2. If needed, the bonding agent may also be applied between the layers 6 and 7 and/or between different, successive layers of the coating 8. The coating 8 and/or the layers 6, 7 preferably consists of a non-metal material and/or non-metal materials 8a, which is and/or are a plastic, in particular a polytetrafluoroethylene (PTFE). The materials 8a of the individual layers 6, 7 of the coating can deviate from each other and be different, and thus the layer 6 can consist of a first material and the layer 7 of a second material. However, it is also possible that the layers 6 and 7 are made from the same material 8a.

In a step i) a recess 9, in particular in the form of a gap, hole or clearance, interrupting the coating 8 is created around a region of the belt 1 to be processed. The production of the heat recess 9 may be carried in a variety of ways. This way, the recess 9 can, as described below, take place by removing material 8a from the coating 8, for example in the context of a repair of the belt 1 or also by connecting free ends 10, 11 of the belt 1 to form an endless belt.

The recess 9 is delimited by opposite sections of the coating 8. As can be seen from FIG. 1, a bottom of the recess 9 may be formed by a coating-free section of the surface 3 of the belt body 2. In this regard, opposite sections of the coating 8, the sections delimiting the recess 9, are separated from each other by the coating-free section of the surface 3 of the belt body 2.

In step i), the coating can be applied to the surface 3 of the belt body 2, wherein at free ends 10, 11 of the belt body 2 extending transversely or obliquely to the side surfaces, one region each of the surface 3 of the belt body 2, which in each case, is delimited on one side by a free end 10, 11 of the belt body 2, is kept free of the coating. The belt body 2 thus remains uncoated in a region adjoining the two free ends 10, 11.

After the coating operation, end edges of the two free ends 10, 11, which are kept free of the coating, can be made to abut one another and connect to each other for producing the recess 9, whereby the belt body 2 is connected to form an endless belt. The two free ends 10 and 11 are preferably connected by means of welding, which causes a weld seam 12. The weld seam 12 can be further processed, for example by grinding.

As can be seen from FIG. 1, the coating 8 can be staggered towards the middle of the recess 9. In this regard, steps are formed in the coating 8. The steps each have an upper side and a front side adjoining it. In the embodiment represented here, the upper side of the first step is formed by the upper side of the layer 6, wherein the front side of the first step connects the upper side of the layer 6 to the free surface of the layer 7, which surface extends essentially in parallel to the surface 3 of the belt body 2. The just mentioned surface of the layer 7 constitutes the upper side of the second step, wherein the front side of the second step connects the upper side of the second step to the surface 3 of the belt body 2.

A level of the upper sides of the steps with respect to the surface 3 of the belt body 2 decreases from an edge of the recess 9 towards a middle of the recess 9. As an alternative to using steps, the coating 8 could also be slanted in the region of the recess 9.

For producing the staggering of the coating 8, the material and/or the materials 8a can be applied to the belt body 2 in layers, wherein first, the layer 7 is applied while leaving out a region around the free ends 10 and 11, and afterwards the layer 6 is applied to the layer 7.

After processing the belt 1 in the region to be processed, for example by applying or removing material to or from the belt body 2 or by welding the two ends 10 and 11 together, in a step ii), the recess 9 is filled up with a material of the same type and/or materials 8a of the same type as that and/or those of the at least one layer 6, 7 of the coating 8. For process reasons, the recess 9 may be filled up with the material or the materials 8a in a partial, complete, or excessive manner, wherein an excessive filling of the recess 9 leads to the material passing over into neighboring regions of the coating.

Particularly preferred, the filling of the recess 9 is carried out by means of a spraying method in which the material or the materials 8a are sprayed onto the belt body 2. As an alternative, methods could be used in which the material or the materials 8a is and/or are applied by brushing, rolling or electrostatic coating, or is and/or are poured into the recess 9. The staggering of the coating 8 shown in FIG. 1 allows achieving a uniform layer thickness in all of these methods for filling the recess 9, as the material or the materials 8a can evenly spread from the middle of the recess 9 towards the edges. Moreover, covering edge regions adjoining the region to be processed can be dispensed with.

Finally, as a matter of form, it should be noted that for ease of understanding of the structure, elements are partially not depicted to scale and/or are enlarged and/or are reduced in size.

### LIST OF REFERENCE NUMBERS

1 belt
2 belt body
3 surface
4 surface
5 side surface
6 layer
7 layer
8 coating
8a material
9 recess
10 end
11 end
12 weld seam

1: A method for processing or producing an endless belt made from a belt (1) with a belt body (2), wherein the belt body (2) has a first surface (3) and a second surface (4), wherein the first surface (3) and the second surface (4) are connected to each other by means of side surfaces (5), wherein each of the side surfaces (5) is smaller than each of the surfaces (3, 4), wherein at least one of the surfaces (3, 4) of the belt (1) is coated with a coating (8) having at least one layer (6, 7), wherein in a step i) a recess (9), in particular a gap-type or hole-type recess, interrupting the coating (8) is created around a region to be processed of the belt (1), which recess (9) is at least partially delimited by opposite sections of the at least one coating (8), wherein after processing the belt (2) in the region to be processed, in a step ii) the recess (9) is at least partially filled up with at least one material (8a) of the same type as the at least one layer (6, 7) of the coating (8).

2: The method according to claim 1, wherein the belt body (2) is made of metal.

3: The method according to claim 1, wherein the coating (8) is made from a non-metal material, in particular from a plastic, for example a polytetrafluoroethylene (PTFE).

4: The method according to claim 1, wherein a bottom (9) of the recess (9) is formed by a coating-free section of the surface (3) of the belt body (2), wherein opposite sections of the coating (8) at least partially delimiting the recess (9) are separated from each other by the coating-free section of the surface (3) of the belt body (2).

5: The method according to claim 1, wherein in step i) the coating is applied to the surface (3) of the belt body (2), wherein at free ends (10, 11) of the belt body (2) extending transversely or obliquely to the side surfaces, one region each of the surface (3) of the belt body (2), which in each case, is delimited on one side by a free end (10, 11) of the belt body (2), is kept free of the coating.

6: The method according to claim 5, wherein after step i) and before step ii), for producing the recess (9), end edges of the two free ends (10, 11), which are kept free of the coating, are made to abut one another and are connected to each other, whereby the belt body (2) is connected to form the endless belt.

7: The method according to claim 6, wherein the two free ends (10, 11) are welded together, forming a weld seam (12).

8: The method according to claim 1, wherein toward the middle of the recess (9), the coating is slanted and/or staggered, in each case forming one up-per side and steps adjoining it and having front sides, wherein in the case of a staggering, a level of the upper sides of the steps decreases from an edge of the recess (9) towards a middle of the recess (9) with respect to the surface (3) of the belt body (2).

9: The method according to claim 1, wherein between step i) and step ii), the coating is removed, forming at least a sloping surface and/or steps, until the surface (3) of the belt body (2) is exposed and on it, the belt body (2) is processed, in particular by grinding and/or cutting out parts of the belt body (2) and inserting material into the belt body (2).

10: The method according to claim 1, wherein a spraying method is used for filling up the recess (9) with the material of the coating.
